(19) United States
(12) Patent Application Publication
(10) Pub. No.: US 2025/0016270 A1
(43) Pub. Date: Jan. 9, 2025

(54) Use of Voice Activity Detection (VAD) or Comfort Noise Generation (CNG) Blank Times or Spaces

(71) Applicant: CenturyLink Intellectual Property LLC, Denver, CO (US)

(72) Inventors: Patrick Giagnocavo, Littleton, CO (US); Michael Stillman, Pensacola, FL (US)

(73) Assignee: CenturyLink Intellectual Property LLC, Denver, CO (US)

(21) Appl. No.: 18/659,768

(22) Filed: May 9, 2024

Related U.S. Application Data
(60) Provisional application No. 63/511,705, filed on Jul. 3, 2023.

(51) Int. Cl. H04M 7/00; G10L 19/012; G10L 25/78

(52) U.S. Cl. CPC H04M 7/006; G10L 19/012; G10L 25/78

(57) ABSTRACT

Novel tools and techniques are provided for implementing use of voice activity detection (“VAD”) or comfort noise generation (“CNG”) blank times or spaces. In various embodiments, a computing system may identify packets that contain no voice signal data among a plurality of packets, which may be exchanged during a voice over Internet Protocol (“VoIP”) communication between user devices. The computing system may embed data within at least one of the identified packets, the embedded data including data that is different from voice signal data contained in the plurality of packets. When the resultant packets have been received and analyzed to determine whether they contain embedded data. Based on a determination that the resultant packets contain embedded data, the embedded data may be extracted. The extracted embedded data may be converted into a form that is accessible to a requesting entity.

### CROSS-REFERENCE TO RELATED APPLICATIONS

This application claims the benefit of U.S. Provisional Application No. 63/511,705 filed Jul. 3, 2023, entitled “Use of Voice Activity Detection (VAD) or Comfort Noise Generation (CNG) Blank Times or Spaces,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing telephone communications and/or data exchange, and, more particularly, to methods, systems, and apparatuses for implementing use of voice activity detection (“VAD”) or comfort noise generation (“CNG”) blank times or spaces.

### BACKGROUND

Over a voice over Internet Protocol (“VoIP”) communication, audio streams in either direction may include periods of silence during which no voice data is included. Voice activity detection (“VAD”) may be used to identify these periods of silence, particularly identifying the packets containing no signal data. Comfort noise signals may be inserted as comfort noise packets into the identified periods or packets. The comfort noise packets, when expanded and decrypted, produce barely detectable noises that indicate to call participants that the VOIP communication remains active despite the silence. The comfort noise packets also serve to reduce the size of packets being sent (e.g., 10's of bytes of comfort noise packets compared with 100's of bytes of data containing null or blank data). It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

FIG. 1 depicts a schematic diagram illustrating an example system for implementing use of voice activity detection (“VAD”) or comfort noise generation (“CNG”) blank times or spaces, in accordance with various embodiments.

FIG. 2 depicts a schematic diagram illustrating a non-limiting example of a voice over Internet Protocol (“VoIP”) communication exchange during which use of VAD or CNG blank times or spaces may be implemented, in accordance with various embodiments.

FIGS. 3A-3C depict schematic diagrams illustrating various non-limiting examples of packet-level implementations of use of VAD or CNG blank times or spaces, in accordance with various embodiments.

FIGS. 4A-4L depict schematic diagrams illustrating various non-limiting examples of types of data that can be inserted or extracted when implementing use of VAD or CNG blank times or spaces, in accordance with various embodiments.

FIGS. 5A and 5B depict flow diagrams illustrating example methods for inserting data and extracting data when implementing use of VAD or CNG blank times or spaces, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing telephone communications and/or data exchange, and, more particularly, to methods, systems, and apparatuses for implementing use of voice activity detection (“VAD”) or comfort noise generation (“CNG”) blank times or spaces.

As discussed above, comfort noise packets are inserted into audio stream packets during voice over Internet Protocol (“VOIP”) communications, in packets that are identified, by VAD, to contain no signal data corresponding to periods of silence during the VOIP communications. The comfort noise packets, when expanded and decrypted, produce barely detectable comfort noises (or comfort tones) that indicate to call participants that the VoIP communication remains active despite the silence. In particular, comfort noise refers to synthetic background noise (e.g., slight buzzing noise, white noise, or other tones, or the like) used in radio and wireless communications to fill artificial silence in a transmission resulting from VAD or from the audio clarity of modern digital lines. The comfort noise packets also serve to reduce the size of packets being sent (e.g., 10's of bytes of comfort noise packets compared with 100's of bytes of data containing null or blank data). In the past, bandwidth was more expensive, and thus the comfort noise packets were used to reduce the bandwidth usage for silent periods (e.g., VAD or CNG blank times or spaces) during VoIP communications.

Bandwidth is no longer as expensive. Accordingly, the comfort noise packets may be replaced or embedded with data packets, such that the VoIP communications may also be used as another medium through which data may be transmitted. The various embodiments utilize these VAD or CNG blank times or spaces.

In various embodiments, a computing system may identify packets that contain no voice signal data among a plurality of packets, which may be exchanged during a voice over Internet Protocol (“VOIP”) communication between user devices. The computing system may embed data within at least one of the identified packets, the embedded data including data that is different from voice signal data contained in the plurality of packets. When the resultant packets have been received and analyzed to determine whether they contain embedded data. Based on a determination that the resultant packets contain embedded data, the embedded data may be extracted. The extracted embedded data may be converted into a form that is accessible to a requesting entity.

These and other aspects of the use of VAD or CNG blank times or spaces to insert data during a voice call (e.g., VoIP call) are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In an aspect, a method may include identifying, by a computing system, one or more first packets that contain no voice signal data among a plurality of packets, the plurality of packets being exchanged during a voice over Internet Protocol (“VoIP”) communication between two or more user devices. The plurality of packets may further include one or more second packets containing voice signal data. The method may further include embedding, by the computing system, first data within at least one third packet, the first data including data that is different from voice signal data contained in the one or more second packets of the plurality of packets; replacing, by the computing system, at least one first packet among the one or more first packets with the embedded at least one third packet; and sending, by the computing system, the embedded at least one third packet along with other packets among the plurality of packets to one or more user devices among the two or more user devices during the VoIP communication.

In some embodiments, the computing system may include at least one of an enhanced voice activity detection-comfort noise generation (“EVAD/CNG”) system, a telephone with EVAD/CNG functionality, a smart phone with an EVAD/CNG software application (“app”), a voice gateway device, a telecommunications node, a server, a distributed computing system, or a cloud computing system, and/or the like.

According to some embodiments, the at least one first packet may include at least one CNG packet. In some cases, each CNG packet may include CNG noise data. In some instances, each CNG noise data may be converted into an analog signal after being received by the one or more user devices. In some examples, the analog signal may be perceptible to users as an audible noise indicative of the VoIP communication still being active during the VOIP communication when participants are not speaking. In some cases, replacing the at least one first packet with the embedded at least one third packet includes, based on a determination that the at least one CNG packet is known in terms of which CNG noise data can be replaced with the embedded at least one third packet without affecting the audible noise perceptible by the users, replacing, by the computing system, the known CNG noise data with the embedded at least one third packet. Alternatively, replacing the at least one first packet with the embedded at least one third packet includes, based on a determination that the at least one CNG packet is unknown or ambiguous in terms of which CNG noise data can be replaced with the embedded at least one third packet without affecting the audible noise perceptible by the users, expanding, by the computing system, the at least one CNG packet to produce expanded CNG sound data; analyzing, by the computing system, the expanded CNG sound data to identify one or more CNG noise data within the at least one CNG packet that can be replaced with the embedded at least one third packet without affecting the audible noise perceptible by the users; and replacing, by the computing system, at least one CNG noise data among the identified one or more CNG noise data with the embedded at least one third packet.

In some instances, the method may further include, after replacing with the embedded at least one third packet, expanding, by the computing system, the embedded at least one third packet and adjacent packets to produce expanded sound data; and comparing, by the computing system, the expanded sound data with corresponding CNG sound data. The method may further include, based on a determination that there is a mismatch between the expanded sound data and the corresponding CNG sound data, analyzing, by the computing system, the expanded sound data to identify one or more other CNG noise data within the at least one CNG packet that can be replaced with the embedded at least one third packet without affecting the audible noise perceptible by the users; replacing, by the computing system, the embedded at least one third packet with at least one CNG noise data among the identified one or more other CNG noise data; and replacing, by the computing system, at least one other CNG noise data among the identified one or more other CNG noise data with the embedded at least one third packet.

In some examples, the at least one first packet may further include one or more blank data packets. In some cases, each blank data packet is a packet with a payload containing null data or blank data. In some instances, replacing the at least one first packet with the embedded at least one third packet may include replacing, by the computing system, at least one blank data packet among the one or more blank data packets with the embedded at least one third packet.

In an example, the first data may include metadata including at least one of date of the VoIP communication, time that the VoIP communication was established, counter, periodic current duration of the VOIP communication, time stamps, speaker identity (“ID”), participant ID, calling number, each called number, audio level, or beacon data, and/or the like. In another example, the first data may include quality of service (“QoS”) metric data including at least one of latency, packet loss, jitter, delay, sound quality, or signal to noise levels, and/or the like. In yet another example, the first data may include authentication data including at least one of call fingerprinting or watermarking data, caller fingerprinting or watermarking data, call device fingerprinting or watermarking data, or unique call identifier data, and/or the like. In still another example, the first data may include authentication code associated with authentication of biometric data of a participant. In some cases, the biometric data may include at least one of fingerprint data, voiceprint data, voiceprint detection data, iris scan data, or facial scan data, and/or the like.

Alternatively, the first data may include attestation data including at least one of hardware attestation data associated with at least one user device among the two or more user devices, embedded attestation key, or software application (“app”)-based authentication, and/or the like. In some instances, the hardware attestation data may include at least one of an international mobile equipment identity (“IMEI”) data, subscriber identity module (“SIM”) card data, an integrated circuit card identification (“ICCID”) number, an international mobile subscriber identity (“IMSI”) number, mobile station integrated services digital network (“MSISDN”) number, or device serial number, and/or the like. In some instances, the VoIP communication occurs over a network, where the first data may further include a level of attestation as set by a telecommunications node in the network. In some cases, the attestation data is exchanged between the two or more user devices autonomously and unknowingly to participants of the VOIP communication. In an example, the first data may include security information including at least one of encryption keys, public keys, or authentication tokens, and/or the like. If a participant only wanted their call fingerprinted, it doesn't matter about the other end. However, if the participant wanted attestation, the other side needs to be able to understand.

According to some embodiments, the method may further include intercepting, by the computing system, the VoIP communication based on law enforcement authorization. In an example, the first data may include law enforcement authorization data including at least one of information associated with requesting law enforcement officer, information associated with law enforcement department or agency, information associated with court authorization, information regarding chain of custody of the intercepted VOIP communication, or information regarding how to obtain law enforcement authorization data, and/or the like.

In another example, the first data may include encrypted control commands. In some embodiments, the encrypted control commands, when decrypted and activated by an authorized entity, may cause remote control of monitoring equipment within one or more devices within range of at least one of the two or more user devices. In some instances, the monitoring equipment may include at least one of one or more audio recording devices, one or more image capture devices, or one or more video recording devices, and/or the like. In yet another example, the first data may include at least one of chat messages, email messages, log data, or file transfer data, and/or the like. In some cases, file transfer data may include at least one of text data, image data, video data, audio data, or multimedia data, and/or the like.

In another aspect, a method may include receiving, by a computing system, a plurality of packets, the plurality of packets being exchanged during a voice over Internet Protocol (“VOIP”) communication between two or more user devices. The plurality of packets may further include one or more second packets containing voice signal data; analyzing, by the computing system, the plurality of packets to determine whether the plurality of packets includes packets containing embedded data in addition to packets containing voice signal data different from the embedded data; and based on a determination that the plurality of packets includes one or more first packets containing embedded first data, extracting, by the computing system, the embedded first data. In some embodiments, the method may further include converting the extracted embedded first data into a form that is accessible to a requesting entity.

In yet another aspect, an enhanced voice activity detection-comfort noise generation (“EVAD/CNG”) system may include at least one first processor and a first non-transitory computer readable medium communicatively coupled to the at least one first processor. The first non-transitory computer readable medium may have stored thereon computer software including a first set of instructions that, when executed by the at least one first processor, causes the EVAD/CNG system to: embed first data within a plurality of packets being exchanged during a voice over Internet Protocol (“VoIP”) communication between two or more user devices. The plurality of packets may include one or more first packets that contain no voice signal data and one or more second packets containing voice signal data. At least one first packet among the one or more first packets may include one or more CNG packets containing CNG noise data. Embedding the first data may include, based on a determination that at least one CNG packet is known in terms of which CNG noise data can be replaced without affecting the audible noise perceptible by the users, replacing the known CNG noise data with at least one third packet embedded with the first data. Alternatively, embedding the first data may include, based on a determination that the at least one CNG packet is unknown or ambiguous in terms of which CNG noise data can be replaced without affecting the audible noise perceptible by the users, expanding the at least one CNG packet to produce expanded CNG sound data; analyzing the expanded CNG sound data to identify one or more CNG noise data within the at least one CNG packet that can be replaced with the embedded at least one third packet without affecting the audible noise perceptible by the users, and replacing at least one CNG noise data among the identified one or more CNG noise data with the at least one third packet embedded with the first data.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

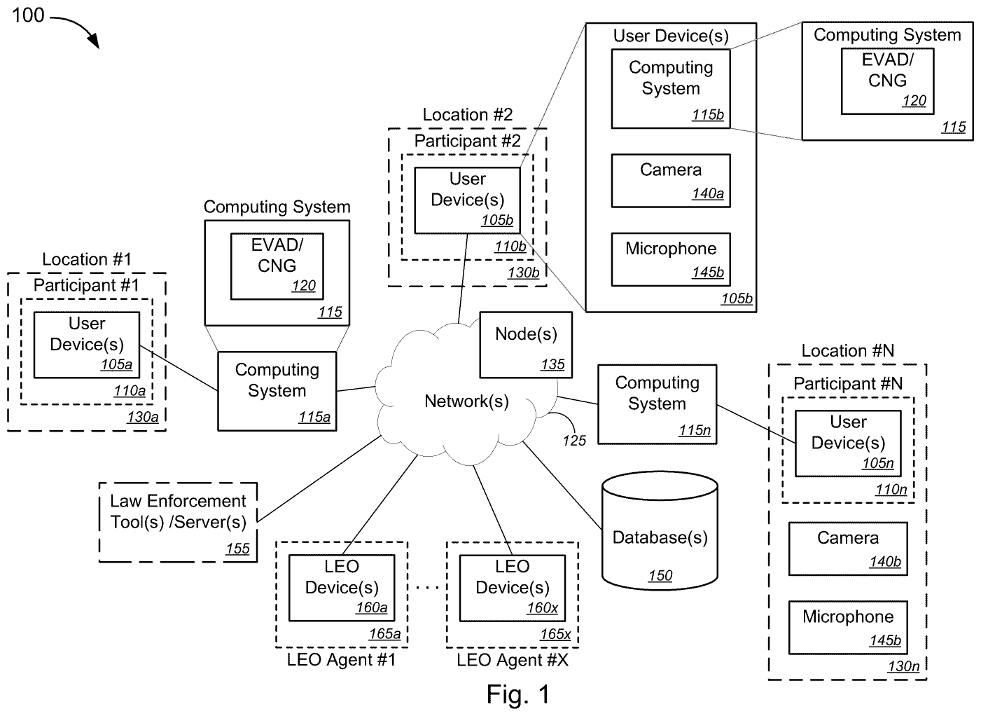

We now turn to the embodiments as illustrated by the drawings. FIGS. 1-6 illustrate some of the features of the method, system, and apparatus for implementing telephone communications and/or data exchange, and, more particularly, to methods, systems, and apparatuses for implementing use of voice activity detection (“VAD”) or comfort noise generation (“CNG”) blank times or spaces, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 depicts a schematic diagram illustrating an example system 100 for implementing use of VAD or CNG blank times or spaces, in accordance with various embodiments.

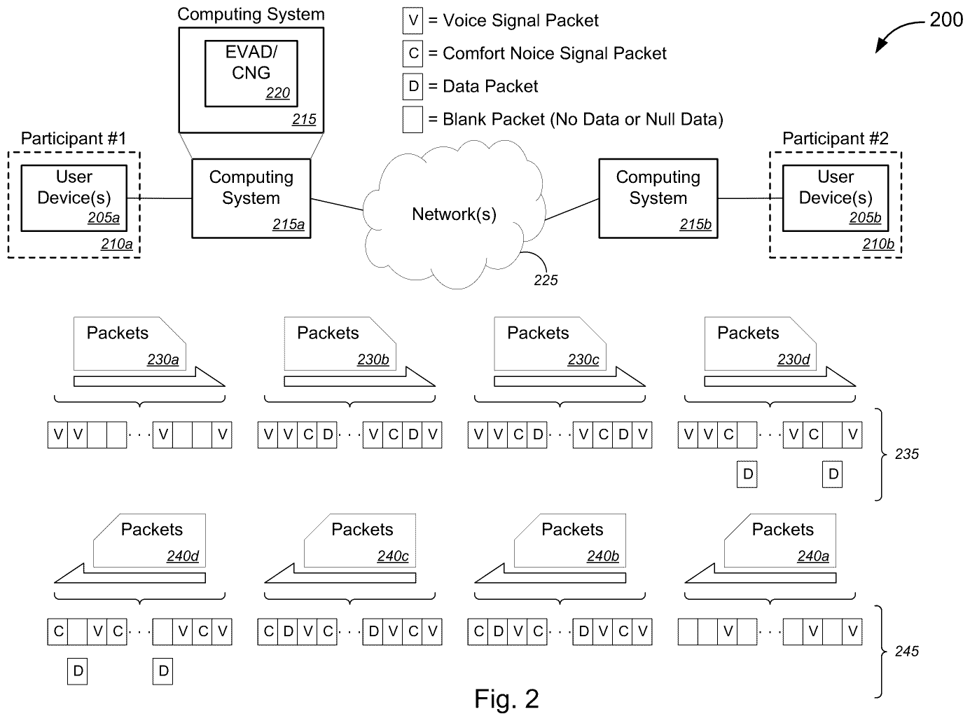

System 100 includes one or more user devices 105a-105n (collectively, “user devices 105” or the like) associated with corresponding one or more participants or call participants #1 to #N 110a-110n (collectively, “participants 110” or the like) located at corresponding one or more locations 130a-130n (collectively, “locations 130” or the like). System 100 may further include one or more computing systems 115a-115n (collectively, “computing systems 115” or the like), each of which may include enhanced VAD/CNG (“EVAD/CNG”) system 120. Each computing system 115 of at least one first set of computing systems among the one or more computing systems 115 may be external to user devices 105 (e.g., computing system 115a and 115n of FIG. 1, or the like), and either may be disposed within network(s) 125 or may be disposed external to, yet communicatively coupled with, network(s) 125. These computing systems 115 communicatively couple user devices 105 with other devices (e.g., other computing systems 115 or other user devices 105) via network(s) 125. In some embodiments, each computing system 115 of the first set of computing systems 115 may include, without limitation, at least one of an enhanced voice activity detection-comfort noise generation (“EVAD/CNG”) system, a voice gateway device, a telecommunications node, a server, a distributed computing system, or a cloud computing system, and/or the like. Alternatively, each computing system 115 of at least one second set of computing systems among the one or more computing systems 115 may be part of a user device 105 (e.g., computing system 115b of FIG. 1, or the like). According to some embodiments, each computing system 115 of the second set of computing systems 115 may include, but is not limited to, at least one of an EVAD/CNG system, a telephone with EVAD/CNG functionality, or a smart phone with an EVAD/CNG software application (“app”), and/or the like. The EVAD/CNG system or functionality is described in greater detail below with respect to FIGS. 2-4.

In some examples, system 100 may further include one or more network nodes 135, through which voice over Internet Protocol (“VOIP”) communications may be routed or managed. The one or more network nodes 135 may be disposed within network(s) 125. Network nodes 135 may set a level of attestation that user devices 105 are required to have to possess for communication to proceed. In some cases, the attestation data is exchanged between the two or more user devices autonomously and unknowingly to participants 110 of the VOIP communications. According to some embodiments, system 100 may further include cameras 140 and microphones 145, such as camera 140a and microphone 145a that are integrated with user device(s) 105b, or camera 140b and microphone 145b that are external to, yet in communication range, of user device(s) 105n, or the like. System 100 may also include database(s) 150, which may be used to store CNG packets, or any of the data that may be inserted into or extracted from packets within the VOIP communications, as described in detail below. Database(s) 150 may be accessible to computing systems 115, EVAD/CNG systems 120, and/or node(s) 135 via network(s) 125.

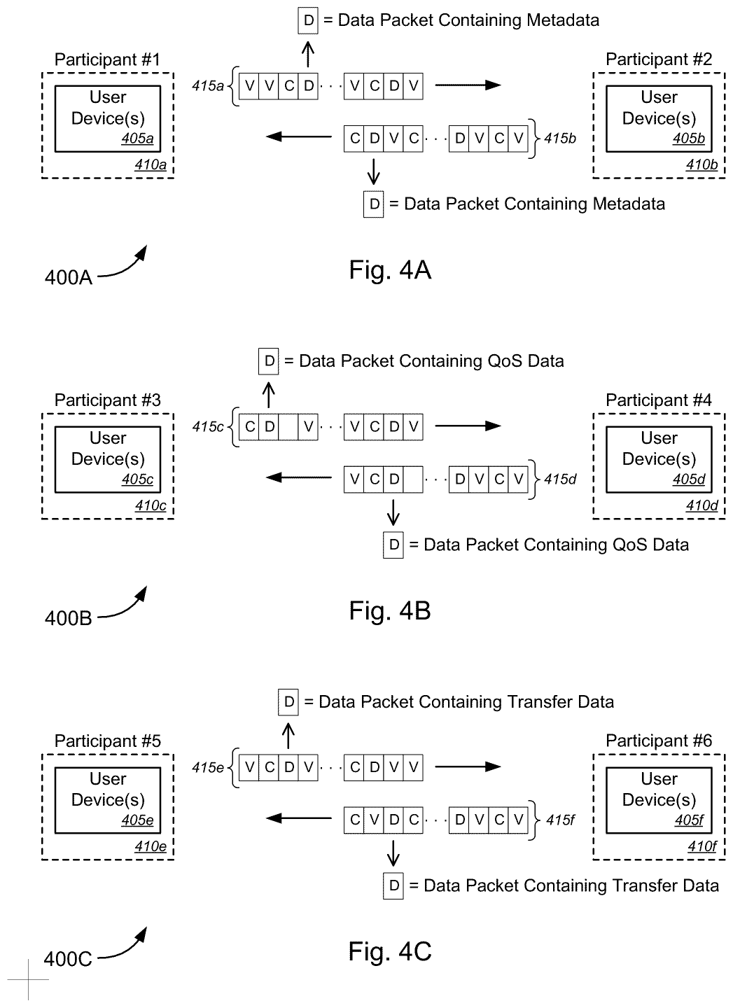

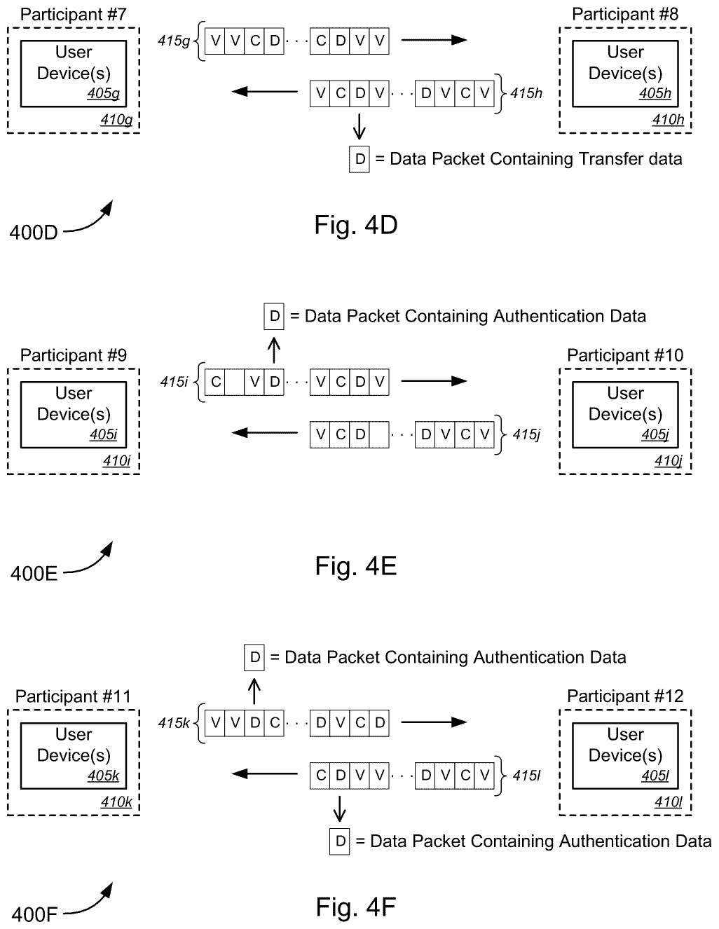

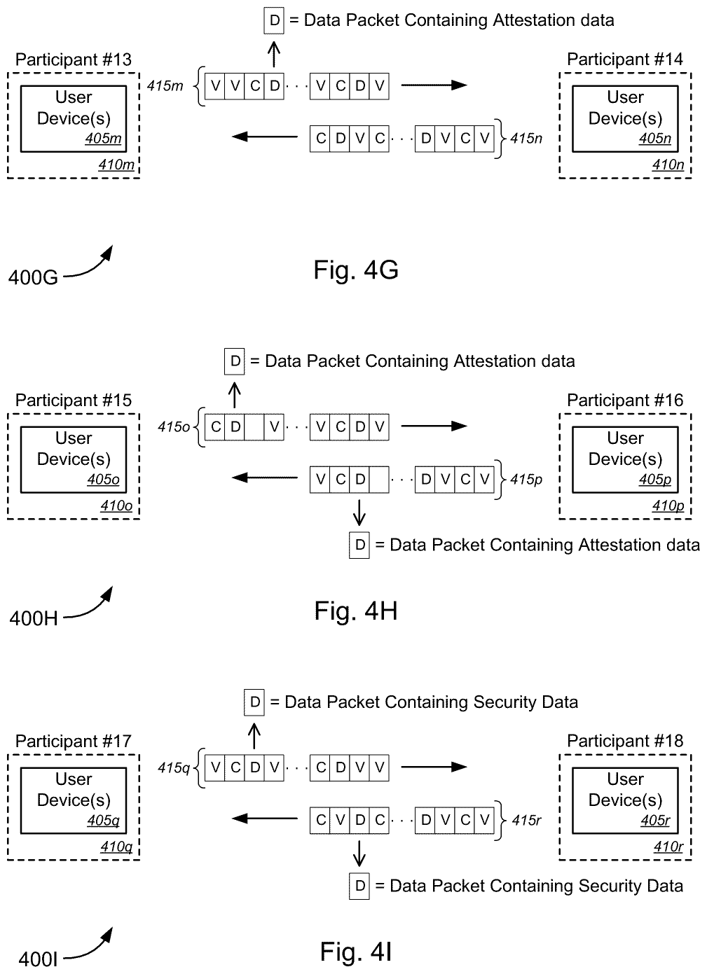

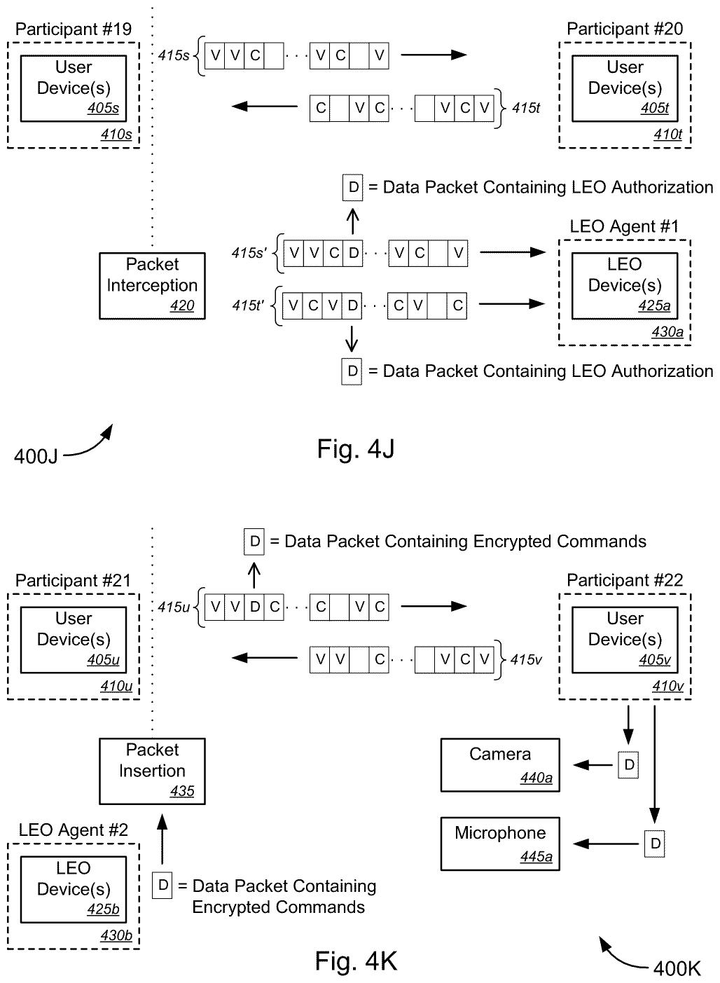

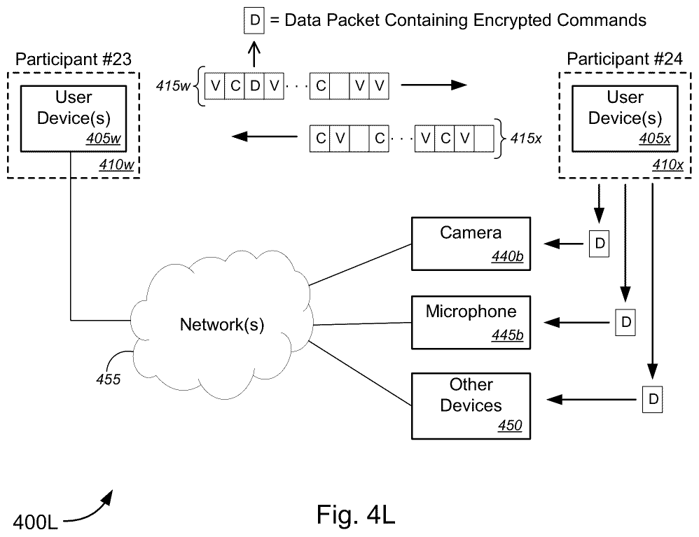

In some embodiments, system 100 may further include law enforcement tool(s) and/or server(s) 155, which may include a packet interception system (e.g., packet interception system 420 of FIG. 4J, or the like) or a packet insertion system (e.g., packet insertion system 425 of FIG. 4K, or the like), and/or the like. System 100 may further include one or more law enforcement organization (“LEO”) devices 160a-160x (collectively, “LEO devices 160” or the like), where x may be the same or different from n. The one or more LEO devices 160 may be associated with, assigned to, and/or used by corresponding one or more LEO agents #1 to #X 165a-165x (collectively, “LEO agents 165” or the like). In some examples, the law enforcement tool(s) and/or server(s) 155 and the one or more LEO devices 160 may communicatively couple with computing systems 115, EVAD/CNG systems 120, node(s) 135, and/or node(s) 135 via network(s) 125, or the like. In some instances, the one or more LEO devices 160 may be similar to user devices 105, except that LEO devices 160 are further configured for law enforcement purposes and may be features configured to facilitate law enforcement operations and/or for greater security.

According to some embodiments, network(s) 125 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 125 may include an access network of the service provider (e.g., an Internet service provider (“ISP”)). In another embodiment, the network(s) 125 may include a core network of the service provider and/or the Internet.

In some instances, the one or more user devices 105 may each include, but is not limited to, one of a desktop computer, a laptop computer, a tablet computer, a smart phone, a mobile phone, or any suitable device capable of VOIP communications over network(s) 125, via a web-based portal, an application programming interface (“API”), a server, a software application (“app”), or any other suitable communications interface, or the like (not shown), over network(s) 125. In some cases, participants 110 may each include, without limitation, one of an individual or a group of individuals, or the like. In some cases, locations 115 may include, but is not limited to, one of a residential customer premises, a business customer premises, a corporate customer premises, an enterprise customer premises, an education facility customer premises, a medical facility customer premises, a governmental customer premises, or any location within range of a telecommunications relay device (e.g., cellular tower, Wi-Fi® hotspot, or wireless access point of a LAN, a WAN, and/or A WWAN, etc.) and/or the like.

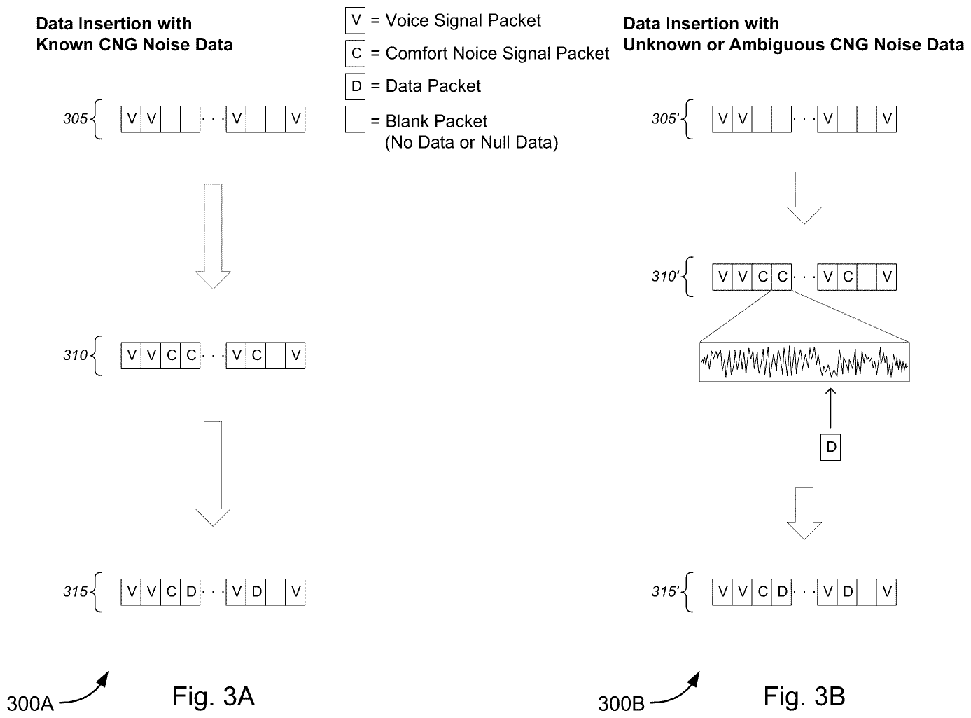

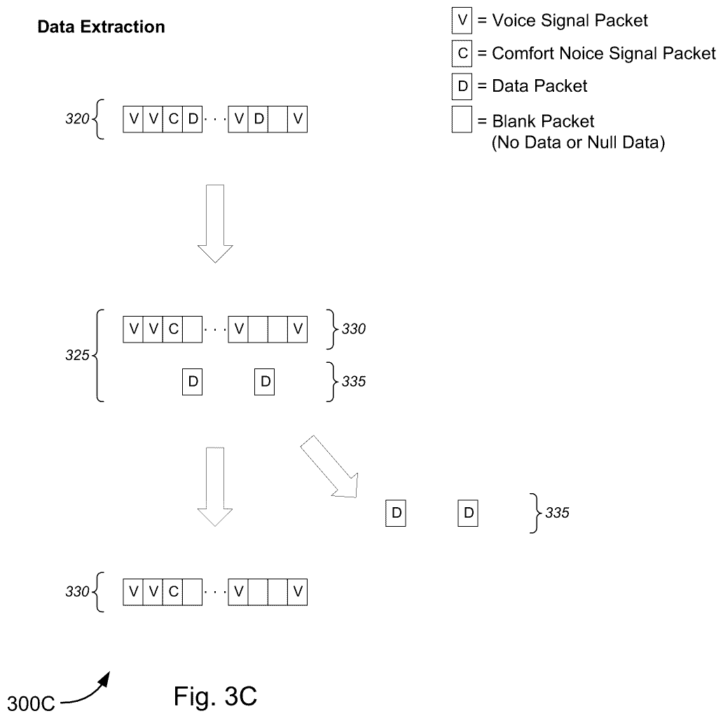

In operation, computing systems 115a-115n and/or EVAD/CNG systems 120 (collectively, “computing system”) may perform methods for implementing use of VAD or CNG blank times or spaces, as described in detail with respect to FIGS. 2-5. For example, data insertion into and extraction from voice signal packets of VOIP communications between user devices are as described below with respect to FIGS. 2 and 3A-3C, while various different use cases for use of VAD or CNG blank times or spaces are as described below with respect to FIGS. 4A-4L. The implementations as described below with respect to FIGS. 2-4L may be applied with respect to the operations of system 100 of FIG. 1.

FIG. 2 depicts a schematic diagram illustrating a non-limiting example 200 of a voice over Internet Protocol (“VOIP”) communication exchange during which use of VAD or CNG blank times or spaces may be implemented, in accordance with various embodiments.

In some embodiments, user devices 205a and 205b, participants 210a and 210b, computing systems 215, 215a, and 215b, EVAD/CNG system(s) 220, and network(s) 225 of FIG. 2 may be similar, if not identical, to the user devices 105a-105n, participants #1 to #N 110a-110n, computing systems 115 and 115a-115n, EVAD/CNG systems 120, and network(s) 125, respectively, of system 100 of FIG. 1, and the description of these components of system 100 of FIG. 1 are similarly applicable to the corresponding components of FIG. 2. Although computing systems 215a and 215b are shown in FIG. 2 as being external to corresponding user devices 205a and 205b, the various embodiments are not so limited, and computing system 215a or 215b may be integrated with corresponding user device 205a or 205b, such as shown with respect to computing system 115b that is integrated with user device 105b in FIG. 1, or the like.

Referring to the non-limiting example 200 of FIG. 2, during a VoIP communication between user devices 205a and 205b (e.g., between participants #1 210a and #2 210b) over network(s) 225, user device 205a may send a plurality of packets 230 to user device 205b via network(s) 225 and via computing systems 215a and 215b. The initial packets 230a may include one or more voice signal packets [V] (depicted by rectangular blocks labelled with “V” in FIG. 2) and one or more blank packets [ ] or [B] (e.g., no data packets, null data packets, or blank data packets; depicted by rectangular blocks labelled with “ ” or empty rectangular blocks in FIG. 2). The voice signal packets [V] correspond to when the participant 210a is speaking, while the blank packets [ ] correspond to when the participant 210a is not speaking or is otherwise silent. After processing by EVAD/CNG system 220 and/or computing system 215a, some of the one or more blank packets [ ] may be replaced either with a comfort noise signal packet [C] (also referred to as a “CNG packet”; denoted by rectangular blocks labelled with “C” in FIG. 2) or with a data packet [D] (depicted by rectangular blocks labelled with “D” in FIG. 2), resulting in intermediate packets 230b, which, if lossless, remain the same (as intermediate packets 230c) going through network(s) 225 until received by computing system 215b (and corresponding EVAD/CNG system 220 (not shown)). Each CNG packet [C] may include CNG noise data. In some instances, each CNG noise data may be converted into an analog signal after being received by the one or more user devices (e.g., user device 205a or 205b). In some examples, the analog signal may be perceptible to users (e.g., participants 210a or 210b) as an audible noise indicative of the VOIP communication still being active during the VoIP communication when participants are not speaking or no sound is being transmitted over the voice channel. Any data packets [D] in intermediate packets 230c are extracted by computing system 215b and/or EVAD/CNG system 220 resulting in final packets 230d, which contain voice signal packets [V], CNG packets [C], and blank packets [ ], with extracted data packets [D] being removed, and reading for conversion into useable data by user device(s) 205b or other devices. The packets 230a-230d are collectively referred to herein as “VoIP communication packets,” while the voice signal packets [V], the CNG packets [C], the blank packets [ ], and the data packets [D] (whether inserted into packets 230 or extracted therefrom) are collectively referred to as “packets 235.”

Similarly, during the same VoIP communication between user devices 205a and 205b (e.g., between participants #2 210b and #1 210a) over network(s) 225, user device 205b may send a plurality of packets 240 to user device 205a via network(s) 225 and via computing systems 215b and 215a. The initial packets 240a may include one or more voice signal packets [V] and one or more blank packets [ ] or [B]. The voice signal packets [V] correspond to when the participant 210b is speaking, while the blank packets [ ] correspond to when the participant 210b is not speaking or is otherwise silent. After processing by EVAD/CNG system 220 (not shown) and/or computing system 215b, some of the one or more blank packets [ ] may be replaced either with a comfort noise signal packet or CNG packet [C] or with a data packet [D], resulting in intermediate packets 240b, which, if lossless, remain the same (as intermediate packets 240c) going through network(s) 225 until received by computing system 215a (and corresponding EVAD/CNG system 220). Any data packets [D] in intermediate packets 240c are extracted by computing system 215a and/or EVAD/CNG system 220 resulting in final packets 240d, which contain voice signal packets [V], CNG packets [C], and blank packets [ ], with extracted data packets [D] being removed, and reading for conversion into useable data by user device(s) 205a or other devices. The packets 240a-240d are collectively referred to herein as “VOIP communication packets,” while the voice signal packets [V], the CNG packets [C], the blank packets [ ], and the data packets [D] (whether inserted into packets 240 or extracted therefrom) are collectively referred to as “packets 245.”

In FIG. 2, the type of packet as described above (e.g., voice signal packet [V], comfort noise signal packet [C], data packet [D], or blank packet [ ]) refers to the content of the payload portion of the particular VOIP communication packets 230 and 240 and/or of the particular packets 235 and 245. Although not shown, each packet 230, 235, 240, or 245 also includes a header portion, which contains information necessary for routing the packet through the network(s) 225 and is not a focus of the various embodiments herein.

In some aspects, real-time transport protocol (“RTP”) is a network protocol for delivering audio and video over IP networks. RTP typically runs over user datagram protocol (“UDP”), and is used in conjunction with real-time transport control protocol (“RTCP”). While RTP carries the media streams (e.g., audio and video), RTCP is used to monitor transmission statistics and quality of service (“QoS”) and aids synchronization of multiple streams. RTP is one of the technical foundations of VoIP and in this context is often used in conjunction with a signaling protocol such as the Session Initiation Protocol (“SIP”), which establishes connections across the network. The various embodiments provide for an encoded, adaptive in-band data storage within VoIP or RTP audio signal for debugging, automated audio quality measurement, tracking, verification, chain of custody, and/or the like. Because calls last multiple seconds, it is acceptable for data encoding to be performed at low bit rates. RTP streams may contain sequence number. If the sequence number has not changed, then CNG data may be used (e.g., packet 1, 2, 3, 4, 5, . . . , 504, 504, 504, . . . , 504 (comfort noise being utilized in that call), 505). Synthetic packets may be created to replace CNG packets.

The various embodiments use “blank” parts of a VOIP phone call, which always occur, to embed counters or other information into the call audio stream itself in a way that is not detectable by the human car. This information can be used to verify that an audio stream was recorded on the equipment it is represented as; or used for debugging and/or automated audio quality measurements; for tracking purposes, or other verification tasks.

In some examples, information may be embedded into recorded audio stream, the information including, but not limited to, information about the time of calls, calling number, or called number. A separate database entry on a different system may record the same information that is encoded in the audio stream. In an example, a stockbrokerage or stockbroker, which has recorded a telephone transaction, can then have additional assurance that the audio stream is legitimate. If packets are dropped, which may result in incomplete information, then the higher-level protocol that uses this data can detect the dropped packets and re-send in another packet.

In another example, multi-factor authentication and attestation may be embedded in the data stream of the VoIP communication. In yet another example, the ability to transfer data in-call can be used for multi-factor authentication in-call. In still another example, attestation of other equipment may be implemented by embedding attestation data in the data stream of the VoIP communication, and the attestation data when extracted can be used to determine if a caller is legitimate or may use of other ways to authenticate. In an example, metadata or meta-information of any form can be stored in the call audio. In another example, information may be tagged in the embedded data in the VoIP communication, e.g., commission on accreditation for law enforcement agencies (“CALEA”) tap. The information may provide information including information regarding requesting officer, information regarding law enforcement department or agency, and how to obtain the information. In yet another example, voiceprint detection and storage inside the call. In still another example, there may be a difference between the information stored between internal-to-company and company-to-other-callers. In an example, watermarking a call. In yet another example, fraud prevention.

In some examples, if more data is needed to be transmitted during the VoIP communication, the system may request that the participants go on hold (e.g., by using a recording of a voice requesting the participants to hold for a number of seconds (e.g., “Please wait 10 seconds while data is being transferred” or “Please hold” or the like). While on hold, the resultant silence provides the system with blank packets (in some cases, with CNG packets as well) in which data packets may be embedded. In some embodiments, the audio streams or packets may be stored for later use. For example, lossless storage of the audio streams or packets allow for forensic analysis of authentication or attestation data, as well as the law enforcement information, or the like. Other uses may be of a transient nature (e.g., embedding of network monitoring data or QoS data in the audio streams or packets, etc.), and thus storage of the audio streams or packets in those cases may be temporary or for a set time duration.

These and other functions of the example 200 (and its components) are described in greater detail herein with respect to FIGS. 1 and 3-5.

FIGS. 3A-3C (collectively, “FIG. 3”) depict schematic diagrams illustrating various non-limiting examples 300A, 300B, and 300C of packet-level implementations of use of VAD or CNG blank times or spaces, in accordance with various embodiments. As in FIG. 2, voice signal packets [V] are depicted by rectangular blocks labelled with “V,” and comfort noise signal packets or CNG packets [C] are denoted by rectangular blocks labelled with “C,” while data packets [D] are depicted by rectangular blocks labelled with “D,” and blank packets [ ] or [B] are depicted by rectangular blocks labelled with “ ” or empty rectangular blocks. In some embodiments, CNG packets may be used as a template for replacing packets with data.

With reference to the non-limiting example 300A of FIG. 3A, which depicts data insertion with known CNG noise data, packets 305, which are VoIP packets containing voice signal packets [V] and blank packets [ ], may be embedded with CNG packets [C] to produce packets 310. Based on a determination that at least one CNG packet [C] is known in terms of which CNG noise data can be replaced with data packets without affecting the audible noise perceptible by the users, the known at least one CNG packet [C] may be with the embedded at least one data packet [D] to produce packets 315. In some cases, the at least one data packet [D] is embedded within portions of the known at least one CNG packet [C] such that, if the resultant packet 315 is expanded to produce expanded sound data, the expanded sound data when played through a speaker (e.g., a speaker of a telephone, smartphone, handset, headset, etc.) would be audibly indistinct from CNG sound data corresponding to the CNG packets [C] prior to embedding of the at least one data packet [D]. In some embodiments, the CNG packets may be used as 250 byte templates, where data bytes may be inserted in portions that do not cause audible changes to the CNG packets. In some examples, the audio strength number (e.g., between 0.0 and 100.0) of a CNG packet may be determined. Some devices do not look at this audio strength number, but may just generate the same packet each time. Other devices may rely on this audio strength number.

Turning to the non-limiting example 300B of FIG. 3B, which depicts data insertion with unknown or ambiguous CNG noise data, packets 305′, which may be similar if not identical to packets 305 of FIG. 3A, may be embedded with CNG packets [C] to produce packets 310′. Based on a determination that at least one CNG packet [C] is unknown or ambiguous in terms of which CNG noise data can be replaced with the at least one data packet [D] without affecting the audible noise perceptible by the users, the CNG sound data may be expanded to identify one or more CNG noise data within the at least one CNG packet that can be replaced with the at least one data packet [D] without affecting the audible noise perceptible by the users. Thereafter, at least one CNG noise data among the identified one or more CNG noise data may be replaced with the at least one data packet [D] to produce packets 315′.

Referring to the non-limiting example 300C of FIG. 3C, which depicts data extraction, packets 320, which may be similar if not identical to packets 315 of FIG. 3A, may contain voice signal packets [V] with blank packets embedded with CNG packets [C] and with data packets [D]. Packets 320 may be analyzed to determine whether it contains packets containing embedded data. Based on a determination that packets 320 contains packets containing embedded data, the embedded data packets [D] may be extracted from packets 320 to produce a set of packets 325 including packets 330 and the extracted data packets [D] 335. The packets 330, when expanded, produce expanded sound data that, when played through a speaker (e.g., a speaker of a telephone, smartphone, handset, headset, etc.), relays voice signal and comfort noise.

These and other functions of the examples 300A, 300B, and 300C (and their components) are described in greater detail herein with respect to FIGS. 1, 2, 4, and 5.

FIGS. 4A-4L (collectively, “FIG. 4”) depict schematic diagrams illustrating various non-limiting examples 400A-400L of types of data that can be inserted or extracted when implementing use of VAD or CNG blank times or spaces, in accordance with various embodiments. As in FIGS. 2 and 3, voice signal packets [V] are depicted by rectangular blocks labelled with “V,” and comfort noise signal packets or CNG packets [C] are denoted by rectangular blocks labelled with “C,” while data packets [D] are depicted by rectangular blocks labelled with “D,” and blank packets [ ] or [B] are depicted by rectangular blocks labelled with “ ” or empty rectangular blocks.

In some embodiments, user devices 405a-405v, participants 410a-410v, LEO devices 425a and 425b, LEO agents 430a and 430b, packet interception system 420 and packet insertion system 435, camera 440, and microphone 445 of FIG. 4 may be similar, if not identical, to the user devices 105a-105n, participants #1 to #N 110a-110n, LEO devices 160a-160x, LEO agents 165a-165x, law enforcement tool(s) and/or server(s) 155, cameras 140a and 140b, and microphones 145a and 145b, respectively, of system 100 of FIG. 1, and the description of these components of system 100 of FIG. 1 are similarly applicable to the corresponding components of FIG. 4.

With reference to the non-limiting example 400A of FIG. 4A, during a VoIP communication between user devices 405a and 405b (e.g., between participants #1 410a and #2 410b) (e.g., over network(s) 125 or 225 of FIGS. 1 and 2, or the like), user device(s) 405a may send a plurality of packets 415a to user device(s) 405b, while user device(s) 405b may send a plurality of packets 415b to user device(s) 405a. At least one of the packets 415a and/or 415b may have embedded therein data packets [D], at least one embedded data packet [D] may include metadata including, but not limited to, at least one of date of the VOIP communication, time that the VoIP communication was established, counter, periodic current duration of the VOIP communication, time stamps, speaker identity (“ID”), participant ID, calling number, each called number, audio level, or beacon data, and/or the like. In some cases, the beacon data may be embedded every 10 or 30 seconds, and/or repeated at 5, 25, 35, 55, or 65 seconds, etc. In an example, additional information such as audio level, speaker identity, and/or timestamps can be embedded in the RTP packet, and such additional information can be used to improve the overall quality of the audio in the VoIP communication and may also be fed into speech recognition engines (e.g., for speech to text features, for speaker identification features, etc.).

Referring to the non-limiting example 400B of FIG. 4B, during a VOIP communication between user devices 405c and 405d (e.g., between participants #3 410c and #4 410d) (e.g., over network(s) 125 or 225 of FIGS. 1 and 2, or the like), user device(s) 405c may send a plurality of packets 415c to user device(s) 405d, while user device(s) 405d may send a plurality of packets 415d to user device(s) 405c. At least one of the packets 415c and/or 415d may have embedded therein data packets [D], at least one embedded data packet [D] may include quality of service (“QoS”) metric data including, but not limited to, at least one of latency, packet loss, jitter, delay, sound quality, or signal to noise levels, and/or the like. In an example, embedding network monitoring data such as packet loss, jitter, and/or delay information can help to improve the overall quality of VOIP communications.

Turning to the non-limiting example 400C of FIG. 4C, during a VoIP communication between user devices 405e and 405f (e.g., between participants #5 410c and #6 410f) (e.g., over network(s) 125 or 225 of FIGS. 1 and 2, or the like), user device(s) 405e may send a plurality of packets 415e to user device(s) 405f, while user device(s) 405f may send a plurality of packets 415f to user device(s) 405c. At least one of the packets 415e and/or 415f may have embedded therein data packets [D], at least one embedded data packet [D] may include transfer data including, but not limited to, at least one of chat messages, email messages, log data, or file transfer data, and/or the like. In some cases, the file transfer data may include at least one of text data, image data, video data, audio data, or multimedia data, and/or the like.

In the non-limiting example 400D of FIG. 4D, during a VoIP communication between user devices 405g and 405h (e.g., between participants #7 410g and #8 410h) (e.g., over network(s) 125 or 225 of FIGS. 1 and 2, or the like), user device(s) 405g may send a plurality of packets 415g to user device(s) 405h, while user device(s) 405h may send a plurality of packets 415h to user device(s) 405g. Packets 415h may have embedded therein data packets [D], at least one embedded data packet [D] may include transfer data including, but not limited to, at least one of chat messages, email messages, log data, or file transfer data, and/or the like. In some cases, the file transfer data may include at least one of text data, image data, video data, audio data, or multimedia data, and/or the like. In an example, embedding data in the RTP packet can be used to transfer small amounts of data during the call, for example, for sending chat messages or file transfer.

With reference to the non-limiting example 400E of FIG. 4E, during a VoIP communication between user devices 405i and 405j (e.g., between participants #9 410i and #10 410j) (e.g., over network(s) 125 or 225 of FIGS. 1 and 2, or the like), user device(s) 405i may send a plurality of packets 415i to user device(s) 405j, while user device(s) 405j may send a plurality of packets 415j to user device(s) 405i. Packets 415i may have embedded therein data packets [D], at least one embedded data packet [D] may include authentication data and/or authentication code associated with authentication of biometric data of a participant. In some examples, authentication data may include, without limitation, at least one of call fingerprinting or watermarking data, caller fingerprinting or watermarking data, call device fingerprinting or watermarking data, or unique call identifier data, and/or the like. In some cases, the biometric data may include at least one of fingerprint data, voiceprint data, voiceprint detection data, iris scan data, or facial scan data, and/or the like.

Referring to the non-limiting example 400F of FIG. 4F, during a VOIP communication between user devices 405k and 405l (e.g., between participants #11 410k and #12 410l) (e.g., over network(s) 125 or 225 of FIGS. 1 and 2, or the like), user device(s) 405k may send a plurality of packets 415k to user device(s) 405l, while user device(s) 405l may send a plurality of packets 415l to user device(s) 405k. At least one of the packets 415k and/or 415l may have embedded therein data packets [D], at least one embedded data packet [D] may include authentication data and/or authentication code associated with authentication of biometric data of a participant. In some examples, authentication data may include, without limitation, at least one of call fingerprinting or watermarking data, caller fingerprinting or watermarking data, call device fingerprinting or watermarking data, or unique call identifier data, and/or the like. In some cases, the biometric data may include at least one of fingerprint data, voiceprint data, voiceprint detection data, iris scan data, or facial scan data, and/or the like.

Turning to the non-limiting example 400G of FIG. 4G, during a VOIP communication between user devices 405m and 405n (e.g., between participants #13 410m and #14 410n) (e.g., over network(s) 125 or 225 of FIGS. 1 and 2, or the like), user device(s) 405m may send a plurality of packets 415m to user device(s) 405n, while user device(s) 405n may send a plurality of packets 415n to user device(s) 405m. Packets 415m may have embedded therein data packets [D], at least one embedded data packet [D] may include attestation data including, but not limited to, at least one of hardware attestation data associated with at least one user device among the two or more user devices, embedded attestation key, or software application (“app”)-based authentication, and/or the like. In some instances, the hardware attestation data may include at least one of an international mobile equipment identity (“IMEI”) data, subscriber identity module (“SIM”) card data, an integrated circuit card identification (“ICCID”) number, an international mobile subscriber identity (“IMSI”) number, mobile station integrated services digital network (“MSISDN”) number, or device serial number, and/or the like. In some instances, the VOIP communication occurs over a network, where the at least one embedded data packet [D] may further include a level of attestation as set by a telecommunications node in the network. In some cases, the attestation data is exchanged between the two or more user devices autonomously and unknowingly to participants of the VoIP communication. The attestation data from the user device of one party or call participant provides an added level of security that ensures the other party or call participant that the former is who that person purports to be. For example, If a spoofing party calls purporting to be an agent of the called party's bank, the use of such attestation data (or in this case, the lack of the appropriate attestation data) would reveal that it is not the called party's bank calling.

In the non-limiting example 400H of FIG. 4H, during a VOIP communication between user devices 4050 and 405p (e.g., between participants #15 4100 and #16 410p) (e.g., over network(s) 125 or 225 of FIGS. 1 and 2, or the like), user device(s) 4050 may send a plurality of packets 4150 to user device(s) 405p, while user device(s) 405p may send a plurality of packets 415p to user device(s) 4050. At least one of the packets 4150 and/or 415p may have embedded therein data packets [D], at least one embedded data packet [D] may include attestation data including, but not limited to, at least one of hardware attestation data associated with at least one user device among the two or more user devices, embedded attestation key, or app-based authentication, and/or the like. In some instances, the hardware attestation data may include at least one of an IMEI data, SIM card data, an ICCID number, an IMSI number, MSISDN number, or device serial number, and/or the like. In some instances, the VoIP communication occurs over a network, where the at least one embedded data packet [D] may further include a level of attestation as set by a telecommunications node in the network. In some cases, the attestation data is exchanged between the two or more user devices autonomously and unknowingly to participants of the VoIP communication.

With reference to the non-limiting example 400I of FIG. 4I, during a VoIP communication between user devices 405q and 405r (e.g., between participants #17 410q and #18 410r) (e.g., over network(s) 125 or 225 of FIGS. 1 and 2, or the like), user device(s) 405q may send a plurality of packets 415q to user device(s) 405r, while user device(s) 405r may send a plurality of packets 415r to user device(s) 405q. At least one of the packets 415q and/or 415r may have embedded therein data packets [D], at least one embedded data packet [D] may include security information including, but not limited to, at least one of encryption keys, public keys, or authentication tokens, and/or the like. In an example, embedding security information such as encryption keys or authentication tokens in the RTP packet can be used to secure the VOIP call.

Referring to the non-limiting example 400J of FIG. 4J, during a VoIP communication between user devices 405s and 405t (e.g., between participants #19 410s and #20 410t) (e.g., over network(s) 125 or 225 of FIGS. 1 and 2, or the like), user device(s) 405s may send a plurality of packets 415s to user device(s) 405t, while user device(s) 405t may send a plurality of packets 415t to user device(s) 405s. A packet interception system 420 may intercept the packets 415s and 415t. The intercepted packets 415s and 415t may be embedded with data packet [D] to produce packets 415s′ and 415t′ prior to being received by LEO device(s) 425a associated with LEO agent #1 430a. The embedded data packet [D] may include law enforcement authorization data including, but not limited to, at least one of information associated with requesting law enforcement officer, information associated with law enforcement department or agency, information associated with court authorization, information regarding chain of custody of the intercepted VoIP communication, or information regarding how to obtain law enforcement authorization data, and/or the like. In an example, embedding data in RTP packets can be used when collecting evidence during an investigation, for example, by including timestamps, audio levels, and other metadata that can be used to authenticate the recorded audio or intercepted audio. Alternatively or additionally, embedding security information in the RTP packet can be used to secure the VoIP call during surveillance or investigation.

Turning to the non-limiting example 400K of FIG. 4K, during a VoIP communication between user devices 405u and 405v (e.g., between participants #21 410u and #22 410v) (e.g., over network(s) 125 or 225 of FIGS. 1 and 2, or the like), user device(s) 405u may send a plurality of packets 415u to user device(s) 405v, while user device(s) 405v may send a plurality of packets 415v to user device(s) 405u. A packet insertion system 435 may insert data packets [D] into the packets 415u, in some cases, by intercepting the packets 415u and subsequently inserting the data packets [D] therein. The data packets [D] may be inserted by the packet insertion 435 in response to instructions by LEO device(s) 425b associated with LEO agent #2 430b. The inserted data packet [D] may include encrypted control commands. In some embodiments, the encrypted control commands, when decrypted and activated by an authorized entity (e.g., LEO agent #2 430b via LEO device(s) 425b), may cause remote control of monitoring equipment within one or more devices within range of user device(s) 405v that receives packets 415u. In some instances, the monitoring equipment may include at least one of one or more audio recording devices, one or more image capture devices, or one or more video recording devices, and/or the like. For example, the one or more audio recording devices may be part of microphone 445a, while the one or more image capture devices and/or one or more video recording devices may be part of camera 440a. The data collected by the monitoring equipment may be stored for later physical retrieval by the LEO agent, 430b or may be transmitted to the LEO device(s) 425b via wireless and/or wired connection (in some cases, via a network(s)) between the monitoring equipment or the devices in which the monitoring equipment is housed and the LEO device(s) 425b (connection not shown in FIG. 4K). In an example, embedding control signals (e.g., encrypted control signals, in some cases, with warrant information and LEO information embedded therewith) in the RTP packet can be used to remotely control a device such as a microphone, a camera, or other audio and/or video equipment for monitoring a situation or suspects during surveillance operation conducted by a law enforcement agency (ies). In some examples, adding encrypted control commands and adding complexity to the process of remotely controlling devices mitigates access and abuse by unauthorized parties (e.g., hackers or the like).

In the non-limiting example 400L of FIG. 4L, during a VoIP communication between user devices 405w and 405x (e.g., between participants #23 410w and #24 410x) (e.g., over network(s) 125 or 225 of FIGS. 1 and 2, or the like), user device(s) 405w may send a plurality of packets 415w to user device(s) 405x, while user device(s) 405x may send a plurality of packets 415x to user device(s) 405w. User device(s) 405w may embed data packets [D] into packets 415w, in response to instructions received by user device(s) 405w from participant #23 410w. The embedded data packet [D] may include encrypted control commands. According to some embodiments, the encrypted control commands, when decrypted and activated by end devices (e.g., camera 440b, microphone 445b, and/or other devices 450, etc.) may enable separate authentication of user device(s) 405x and/or participant #24 410x. In an example, participant #24 410x may visit the home of participant #23 410w while participant #23 410w is not at home. Participant #23 410x may call participant #23 410w. During the VOIP communication, user device(s) 405w may embed at least one data packet containing encrypted commands within CNG packets or blank packets in packets 415w. When received by user device(s) 405x, the encrypted commands may be received by the end devices located at the home of participant #23 410w. For example, camera 440b and microphone 445b, which may be located at or near the front door, may record images or videos of participant #24, and may send the recordings via network 455 to user device(s) 405w via wireless and/or wired communications. User device(s) 405w and/or other intermediate computing system(s) may compare at least the audio signal recorded by the microphone 445b with the audio signal [V] in packets 415x to confirm if the same person at the front door of the home is talking with participant #23 over the VOIP communication. The camera recordings may allow the participant #23 410w to visually confirm identity of participant #24. Once identity has been verified, further encrypted commands may be subsequently embedded into packets 415w in the manner described above for controlling other devices 450 (such as an electronic front door lock to unlock to allow entry for participant #24 410x into the home, and/or porch lights or other lights to illuminate the front of the home for better image or video recording by camera 440b, and/or interior lights to illuminate inner entry ways or other interior spaces in the home after allowing entry to participant #24 410x, or the like). Although not shown, authentication or attestation data may also be exchanged in a manner as shown and described above with respect to FIGS. 4E-4H (where the one-way sending of authentication or attestation data in FIGS. 4E and 4G are performed by user device(s) 405x).

In the various embodiments above, the user devices 405 (and/or other devices 420, 435, and/or 440-450, etc.) are configured to embed the data packets and/or to extract the data packets in the manner as shown and described above with respect to FIGS. 2 and 3. The devices 440-450 are configured (either via software or via firmware) to be able to recognize, interpret, decrypt, and executed the encrypted commands that are sent as embedded data in the audio signals. In an example, the embedded encrypted data when expanded and reproduced as an audio signal, is received and recognized by the devices 440-450, and converted or interpreted (by devices 440-450) into a form that, when decrypted, becomes executable control commands for activating particular functions of the devices 440-450. These and other functions of the examples 400A-400L (and their components) are described in greater detail herein with respect to FIGS. 1-3 and 5.

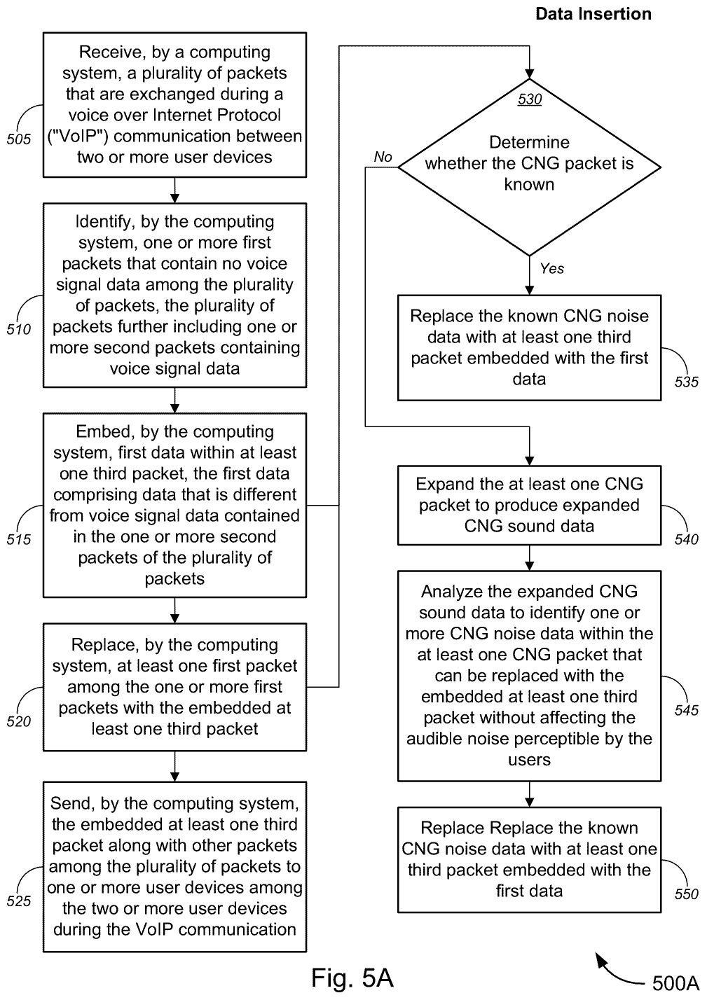

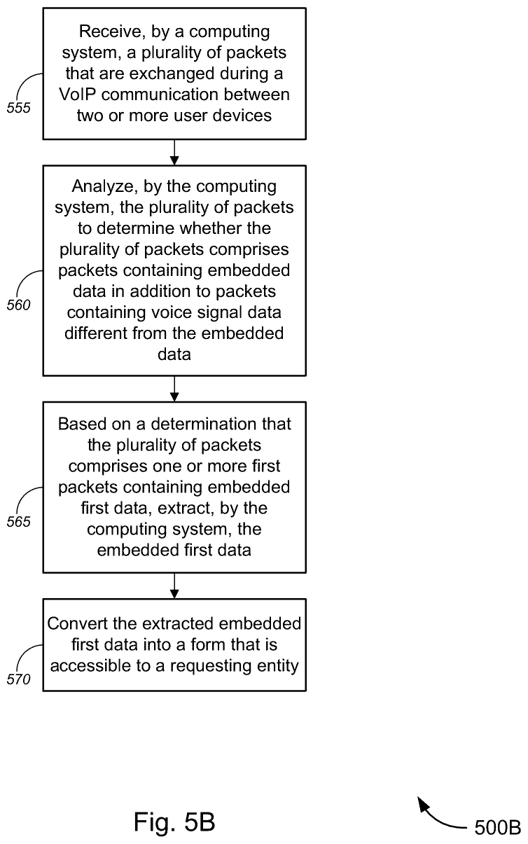

FIGS. 5A and 5B (collectively, “FIG. 5”) depict flow diagrams illustrating example methods 500A and 500B for inserting data and extracting data, respectively, when implementing use of VAD or CNG blank times or spaces, in accordance with various embodiments. FIG. 5A depicts processes for implementing data insertion during implementation of the use of VAD or CNG blank times or spaces, while FIG. 5B depicts processes for implementing data extraction during implementation of the use of VAD or CNG blank times or spaces.

While the techniques and procedures are depicted and/or described in a certain order for purposes of illustration, it should be appreciated that certain procedures may be reordered and/or omitted within the scope of various embodiments. Moreover, while the method 500A or 500B illustrated by FIG. 5A or 5B can be implemented by or with (and, in some cases, are described below with respect to) the systems, examples, or embodiments 100, 200, 300A-300C, and 400A-400L of FIGS. 1, 2, 3, and 4, respectively (or components thereof), such methods may also be implemented using any suitable hardware (or software) implementation. Similarly, while each of the systems, examples, or embodiments 100, 200, 300A-300C, and 400A-400L of FIGS. 1, 2, 3, and 4, respectively (or components thereof), can operate according to the method 500A or 500B illustrated by FIG. 5A or 5B (e.g., by executing instructions embodied on a computer readable medium), the systems, examples, or embodiments 100, 200, 300A-300C, and 400A-400L of FIGS. 1, 2, 3, and 4 can each also operate according to other modes of operation and/or perform other suitable procedures.

In the non-limiting embodiment of FIG. 5A, method 500A, at operation 505, may include receiving, by a computing system, a plurality of packets that are exchanged during a VoIP communication between two or more user devices. At operation 510, method 500A may include identifying, by the computing system, one or more first packets that contain no voice signal data among the plurality of packets, the plurality of packets further including one or more second packets containing voice signal data. Method 500A may include, at operation 515, embedding, by the computing system, first data within at least one third packet, the first data comprising data that is different from voice signal data contained in the one or more second packets of the plurality of packets. Method 500A may further include replacing, by the computing system, at least one first packet among the one or more first packets with the embedded at least one third packet (operation 520). Method 500A may further include, at operation 525, sending, by the computing system, the embedded at least one third packet along with other packets among the plurality of packets to one or more user devices among the two or more user devices during the VoIP communication.

In some embodiments, the computing system may include at least one of an EVAD/CNG system, a telephone with EVAD/CNG functionality, a smart phone with an EVAD/CNG app, a voice gateway device, a telecommunications node, a server, a distributed computing system, or a cloud computing system, and/or the like. According to some embodiments, the at least one first packet may include at least one CNG packet. In some cases, each CNG packet may include CNG noise data. In some instances, each CNG noise data may be converted into an analog signal after being received by the one or more user devices. In some examples, the analog signal may be perceptible to users as an audible noise indicative of the VOIP communication still being active during the VOIP communication when participants are not speaking.

According to some embodiments, the at least one first packet may include at least one CNG packet, each CNG packet including CNG noise data. Each CNG noise data is converted into an analog signal after being received by the one or more user devices, where the analog signal is perceptible to users as an audible noise indicative of the VoIP communication still being active during the VoIP communication when participants are not speaking. In some examples, embedding the first data within the at least one third packet (at operation 515) and/or replacing the at least one first packet with the embedded at least one third packet (at operation 520) may include, at operation 530, determining whether a CNG packet is known in terms of which CNG noise data can be replaced with the embedded at least one third packet without affecting the audible noise perceptible by the users. If so, method 500A may continue onto the process at operation 535. If not, method 500A may continue onto the process at operation 540.

At operation 535, method 500A may include, based on a determination that the at least one CNG packet is known in terms of which CNG noise data can be replaced with the embedded at least one third packet without affecting the audible noise perceptible by the users, replacing, by the computing system, the known CNG noise data with the embedded at least one third packet. Alternatively, method 500A may include, based on a determination that the at least one CNG packet is unknown or ambiguous in terms of which CNG noise data can be replaced with the embedded at least one third packet without affecting the audible noise perceptible by the users, expanding, by the computing system, the at least one CNG packet to produce expanded CNG sound data (at operation 540); analyzing, by the computing system, the expanded CNG sound data to identify one or more CNG noise data within the at least one CNG packet that can be replaced with the embedded at least one third packet without affecting the audible noise perceptible by the users (at operation 545); and replacing, by the computing system, at least one CNG noise data among the identified one or more CNG noise data with the embedded at least one third packet (at operation 550).

In some examples, although not shown in FIG. 5A, method 500A may further include, after replacing with the embedded at least one third packet, expanding, by the computing system, the embedded at least one third packet and adjacent packets to produce expanded sound data; and comparing, by the computing system, the expanded sound data with corresponding CNG sound data. The method 500A may further include, based on a determination that there is a mismatch between the expanded sound data and the corresponding CNG sound data, analyzing, by the computing system, the expanded sound data to identify one or more other CNG noise data within the at least one CNG packet that can be replaced with the embedded at least one third packet without affecting the audible noise perceptible by the users; replacing, by the computing system, the embedded at least one third packet with at least one CNG noise data among the identified one or more other CNG noise data; and replacing, by the computing system, at least one other CNG noise data among the identified one or more other CNG noise data with the embedded at least one third packet.

In some embodiments, the at least one first packet may further include one or more blank data packets. In some cases, each blank data packet is a packet with a payload containing null data or blank data. In some instances, replacing the at least one first packet with the embedded at least one third packet may include replacing, by the computing system, at least one blank data packet among the one or more blank data packets with the embedded at least one third packet. The types of first data are shown and described above with respect to FIGS. 1-4.

With reference to the non-limiting embodiment of FIG. 5B, method 500B may include, at operation 555, receiving, by a computing system, a plurality of packets, the plurality of packets being exchanged during a VoIP communication between two or more user devices. The plurality of packets may further include one or more second packets containing voice signal data. Method 500B may further include, at operation 560, analyzing, by the computing system, the plurality of packets to determine whether the plurality of packets includes packets containing embedded data in addition to packets containing voice signal data different from the embedded data. At operation 565, method 500B may include, based on a determination that the plurality of packets includes one or more first packets containing embedded first data, extracting, by the computing system, the embedded first data. In some embodiments, method 500B may further include converting the extracted embedded first data into a form that is accessible to a requesting entity (at operation 570).

### Exemplary System and Hardware Implementation

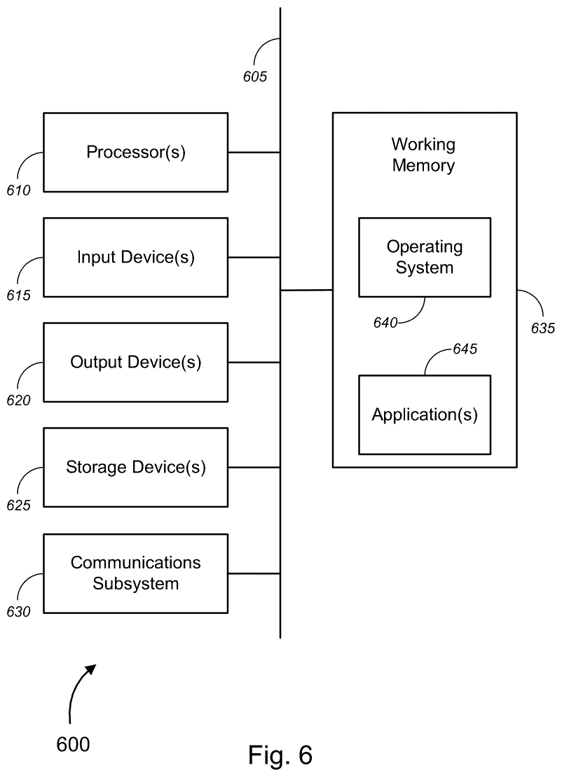

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., user devices 105a-105n, 205a, 205b, and 405a-405v, computing system 115, 115a-115n, 215a, and 215b, network node(s) 135, law enforcement tool(s)/server(s) 155 (including packet interception system 420, packet insertion system 425, etc.), law enforcement organization (“LEO”) devices 160a-160x, 425a, and 425b, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., user devices 105a-105n, 205a, 205b, and 405a-405v, computing system 115, 115a-115n, 215a, and 215b, network node(s) 135, law enforcement tool(s)/server(s) 155 (including packet interception system 420, packet insertion system 425, etc.), LEO devices 160a-160n, 425a, and 425b, etc.), described above with respect to FIGS. 1-5—is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
identifying, by a computing system, one or more first packets that contain no voice signal data among a plurality of packets, the plurality of packets being exchanged during a voice over Internet Protocol (“VoIP”) communication between two or more user devices, the plurality of packets further comprising one or more second packets containing voice signal data;
embedding, by the computing system, first data within at least one third packet, the first data comprising data that is different from voice signal data contained in the one or more second packets of the plurality of packets;
replacing, by the computing system, at least one first packet among the one or more first packets with the embedded at least one third packet; and
sending, by the computing system, the embedded at least one third packet along with other packets among the plurality of packets to one or more user devices among the two or more user devices during the VoIP communication.

2. The method of claim 1, wherein the computing system comprises at least one of an enhanced voice activity detection-comfort noise generation (“EVAD/CNG”) system, a telephone with EVAD/CNG functionality, a smart phone with an EVAD/CNG software application (“app”), a voice gateway device, a telecommunications node, a server, a distributed computing system, or a cloud computing system.

3. The method of claim 1, wherein the at least one first packet comprises at least one CNG packet, wherein each CNG packet comprises CNG noise data, wherein each CNG noise data is converted into an analog signal after being received by the one or more user devices, wherein the analog signal is perceptible to users as an audible noise indicative of the VOIP communication still being active during the VoIP communication when participants are not speaking.

4. The method of claim 3, wherein replacing the at least one first packet with the embedded at least one third packet comprises one of:
based on a determination that the at least one CNG packet is known in terms of which CNG noise data can be replaced with the embedded at least one third packet without affecting the audible noise perceptible by the users, replacing, by the computing system, the known CNG noise data with the embedded at least one third packet; or
based on a determination that the at least one CNG packet is unknown or ambiguous in terms of which CNG noise data can be replaced with the embedded at least one third packet without affecting the audible noise perceptible by the users, performing the following:
expanding, by the computing system, the at least one CNG packet to produce expanded CNG sound data;
analyzing, by the computing system, the expanded CNG sound data to identify one or more CNG noise data within the at least one CNG packet that can be replaced with the embedded at least one third packet without affecting the audible noise perceptible by the users; and
replacing, by the computing system, at least one CNG noise data among the identified one or more CNG noise data with the embedded at least one third packet.

5. The method of claim 4, further comprising:
after replacing with the embedded at least one third packet, expanding, by the computing system, the embedded at least one third packet and adjacent packets to produce expanded sound data;
comparing, by the computing system, the expanded sound data with corresponding CNG sound data;
based on a determination that there is a mismatch between the expanded sound data and the corresponding CNG sound data, performing the following:
analyzing, by the computing system, the expanded sound data to identify one or more other CNG noise data within the at least one CNG packet that can be replaced with the embedded at least one third packet without affecting the audible noise perceptible by the users;
replacing, by the computing system, the embedded at least one third packet with at least one CNG noise data among the identified one or more other CNG noise data; and
replacing, by the computing system, at least one other CNG noise data among the identified one or more other CNG noise data with the embedded at least one third packet.

6. The method of claim 3, wherein the at least one first packet further comprises one or more blank data packets, wherein each blank data packet is a packet with a payload containing null data or blank data, wherein replacing the at least one first packet with the embedded at least one third packet comprises replacing, by the computing system, at least one blank data packet among the one or more blank data packets with the embedded at least one third packet.

7. The method of claim 1, wherein the first data comprises metadata comprising at least one of date of the VOIP communication, time that the VOIP communication was established, counter, periodic current duration of the VoIP communication, time stamps, speaker identity (“ID”), participant ID, calling number, each called number, audio level, or beacon data.

8. The method of claim 1, wherein the first data comprises quality of service (“QoS”) metric data comprising at least one of latency, packet loss, jitter, delay, sound quality, or signal to noise levels.

9. The method of claim 1, wherein the first data comprises authentication data comprising at least one of call fingerprinting or watermarking data, caller fingerprinting or watermarking data, call device fingerprinting or watermarking data, or unique call identifier data.

10. The method of claim 1, wherein the first data comprises authentication code associated with authentication of biometric data of a participant, wherein the biometric data comprises at least one of fingerprint data, voiceprint data, voiceprint detection data, iris scan data, or facial scan data.

11. The method of claim 1, wherein the first data comprises attestation data comprising at least one of hardware attestation data associated with at least one user device among the two or more user devices, embedded attestation key, or software application (“app”)-based authentication, wherein the hardware attestation data comprises at least one of an international mobile equipment identity (“IMEI”) data, subscriber identity module (“SIM”) card data, an integrated circuit card identification (“ICCID”) number, an international mobile subscriber identity (“IMSI”) number, mobile station integrated services digital network (“MSISDN”) number, or device serial number.

12. The method of claim 11, wherein the VOIP communication occurs over a network, wherein the first data further comprises a level of attestation as set by a telecommunications node in the network.

13. The method of claim 11, wherein the attestation data is exchanged between the two or more user devices autonomously and unknowingly to participants of the VoIP communication.

14. The method of claim 1, wherein the first data comprises security information comprising at least one of encryption keys, public keys, or authentication tokens.

15. The method of claim 1, further comprising:
intercepting, by the computing system, the VOIP communication based on law enforcement authorization, wherein the first data comprises law enforcement authorization data comprising at least one of information associated with requesting law enforcement officer, information associated with law enforcement department or agency, information associated with court authorization, information regarding chain of custody of the intercepted VOIP communication, or information regarding how to obtain law enforcement authorization data.

16. The method of claim 1, wherein the first data comprises encrypted control commands, wherein the encrypted control commands, when decrypted and activated by an authorized entity, cause remote control of monitoring equipment within one or more devices within range of at least one of the two or more user devices, wherein the monitoring equipment comprises at least one of one or more audio recording devices, one or more image capture devices, or one or more video recording devices.

17. The method of claim 1, wherein the first data comprises at least one of chat messages, email messages, log data, or file transfer data, wherein file transfer data comprises at least one of text data, image data, video data, audio data, or multimedia data.

18. A method, comprising:
receiving, by a computing system, a plurality of packets, the plurality of packets being exchanged during a voice over Internet Protocol (“VoIP”) communication between two or more user devices, the plurality of packets further comprising one or more second packets containing voice signal data;
analyzing, by the computing system, the plurality of packets to determine whether the plurality of packets comprises packets containing embedded data in addition to packets containing voice signal data different from the embedded data; and
based on a determination that the plurality of packets comprises one or more first packets containing embedded first data, extracting, by the computing system, the embedded first data.

19. The method of claim 18, further comprising:
converting the extracted embedded first data into a form that is accessible to a requesting entity.

20. A enhanced voice activity detection-comfort noise generation (“EVAD/CNG”) system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the EVAD/CNG system to:
embed first data within a plurality of packets being exchanged during a voice over Internet Protocol (“VoIP”) communication between two or more user devices, the plurality of packets comprising one or more first packets that contain no voice signal data and one or more second packets containing voice signal data, wherein at least one first packet among the one or more first packets comprises one or more CNG packets containing CNG noise data, wherein embedding the first data comprises one of:
based on a determination that at least one CNG packet is known in terms of which CNG noise data can be replaced without affecting the audible noise perceptible by the users, replacing the known CNG noise data with at least one third packet embedded with the first data; or
based on a determination that the at least one CNG packet is unknown or ambiguous in terms of which CNG noise data can be replaced without affecting the audible noise perceptible by the users, performing the following:
expanding the at least one CNG packet to produce expanded CNG sound data;
analyzing the expanded CNG sound data to identify one or more CNG noise data within the at least one CNG packet that can be replaced with the embedded at least one third packet without affecting the audible noise perceptible by the users, and
replacing at least one CNG noise data among the identified one or more CNG noise data with the at least one third packet embedded with the first data.
